(19) United States
(12) Patent Application Publication
(10) Pub. No.: US 2017/0345356 A1
(43) Pub. Date: Nov. 30, 2017

(54) Display Driving Apparatus And Operating Method Thereof

(71) Applicant: Raydium Semiconductor Corporation, Hsinchu (TW)

(72) Inventors: SHANG-PING TANG, Zhubei City (TW); CHIEN-LIN HUANG, Hsinchu City (TW); SHAO-PING HUNG, Hsinchu City (TW)

(21) Appl. No.: 15/603,596

(22) Filed: May 24, 2017

Related U.S. Application Data
(60) Provisional application No. 62/343,155, filed on May 31, 2016.

(51) Int. Cl. G09G 3/20; G09G 3/3208

(52) U.S. Cl. CPC G09G 3/2003; G09G 3/3208; G09G 3/2092; G09G 2340/02; G09G 2330/023

(57) ABSTRACT

A display driving apparatus includes a compression module, a storing module, a reading control module and a decompression module. The compression module performs 1-bit compression on an input data signal to generate a 1-bit compressed data and non-black data and store them in the storing module. The non-black data includes color information of each non-black bit in the input data signal. The reading control module reads the 1-bit compressed data from the storing module and the decompression module performs 1-bit decompression on the 1-bit compressed data to generate an output data signal. When the decompression module performs 1-bit decompression, the decompression module determines whether each bit of the 1-bit compressed data corresponds to black. If yes, the bit is displayed in black; if no, the reading control module reads a color corresponding to the bit from the non-black data stored in the storing module and the bit is displayed in the color.

### BACKGROUND OF THE INVENTION

### 1. Field of the Invention

This invention relates to a display, especially to a display driving apparatus applied to a display and an operating method thereof.

### 2. Description of the Prior Art

In general, when the display driving IC having a frame memory is operated, all display data stored in the frame memory will be read out and transmitted to the display. Even the display operated in a power saving mode only needs to display time and few images and most of other regions display black color, all pixels of the display data stored in the frame memory are still read out for the display to display. Its advantage lies in that the image displayed on the display will be not distorted; however, it should read display data toward entire frame memory resulting in a significant increase in power consumption for memory access.

In order to overcome the above-mentioned problems, the 1-bit compression technology is currently used to compress 24-bits display data into 1-bit display data and the 1-bit display data is stored in the 1-bit memory, so that the required memory capacity and the power consumption for memory access can be largely reduced. However, the image displayed on the display will be distorted and the display quality of the display will also become poor, the visual experience of the user will be seriously affected.

### SUMMARY OF THE INVENTION

Therefore, the invention provides a display driving apparatus and an operating method thereof to solve the above-mentioned problems in the prior arts.

An embodiment of the invention is a display driving apparatus. In this embodiment, the display driving apparatus includes a compression module, a storing module, a reading control module and a decompression module. The compression module performs 1-bit compression on an input data signal to generate a 1-bit compressed data and non-black data and store them in the storing module. The non-black data includes color information of each non-black bit in the input data signal. The reading control module reads the 1-bit compressed data from the storing module and the decompression module performs 1-bit decompression on the 1-bit compressed data to generate an output data signal. When the decompression module performs 1-bit decompression, the decompression module determines whether each bit of the 1-bit compressed data corresponds to black. If yes, the bit is displayed in black; if no, the reading control module reads a color corresponding to the bit from the non-black data stored in the storing module and the bit is displayed in the color.

In an embodiment, the display panel is an OLED display panel.

In an embodiment, the compression module includes a 1-bit compression unit and a first determination unit. The 1-bit compression unit is used for performing the 1-bit compression on the input data signal and outputting the 1-bit compressed data. The first determination unit is used for determining whether each bit of the input data signal corresponds to black respectively and generating the non-black data including the color information of the each non-black bit in the input data signal accordingly.

In an embodiment, the decompression module includes a 1-bit decompression unit and a second determination unit. The 1-bit decompression unit is used for performing the 1-bit decompression on the 1-bit compressed data. The second determination unit is used for determining whether each bit of the 1-bit compressed data corresponds to black respectively; if yes, the bit is directly displayed in black; if no, the reading control module reads the color corresponding to the bit from the non-black data stored in the storing module and the bit is displayed in the color.

In an embodiment, the display driving apparatus further includes a writing control module. The writing control module is coupled between the compression module and the storing module and used for writing the 1-bit compressed data and the non-black data into the storing module.

Another embodiment of the invention is a display driving apparatus operating method. In this embodiment, the display driving apparatus operating method is used for operating a display driving apparatus. The display driving apparatus is coupled to a display panel and includes a storing module. The display driving apparatus operating method includes steps of: (a) performing 1-bit compression on an input data signal to generate a 1-bit compressed data and a non-black data, wherein the non-black data includes color information of each non-black bit in the input data signal; (b) storing the 1-bit compressed data and the non-black data in the storing module; and (c) reading the 1-bit compressed data from the storing module and performing 1-bit decompression on the 1-bit compressed data to generate an output data signal; wherein the step (c) is to determine whether each bit of the 1-bit compressed data corresponds to black respectively; if yes, directly displaying the bit in black; if no, reading a color corresponding to the bit from the non-black data stored in the storing module and displaying the bit in the color.

Compared to the prior art, the display driving apparatus and operating method thereof in the invention not only can compress the display data with high compression ratio to reduce the required memory capacity and the power consumption for memory access, but also can display image without distortions. Therefore, the above-mentioned problems occurred in the prior arts can be solved by the display driving apparatus and operating method thereof in the invention.

The advantage and spirit of the invention may be understood by the following detailed descriptions together with the appended drawings.

### BRIEF DESCRIPTION OF THE APPENDED DRAWINGS

FIG. 1 illustrates a functional block diagram of the display driving apparatus in a preferred embodiment of the invention.

FIG. 2A illustrates an embodiment of the compression module.

FIG. 2B illustrates an embodiment of the decompression module.

FIG. 3 illustrates a flowchart of the display driving apparatus operating method in another preferred embodiment of the invention.

### DETAILED DESCRIPTION OF THE INVENTION

A preferred embodiment of the invention is a display driving apparatus. In this embodiment, the display driving apparatus can be a driving IC in a display apparatus for driving different kinds of display panel, such as a liquid crystal display panel or an OLED display panel, but not limited to this.

Please refer to FIG. 1. FIG. 1 illustrates a functional block diagram of the display driving apparatus in this embodiment.

As shown in FIG. 1, the display driving apparatus 1 includes a compression module 10, a writing control module 12, a storing module 14, a reading control module 16 and a decompression module 18. Wherein, the compression module 10 is coupled to the writing control module 12; the writing control module 12 is coupled to the storing module 14; the storing module 14 is coupled to the reading control module 16; the reading control module 16 is coupled to the decompression module 18. In fact, the display driving apparatus 1 can be coupled to the display panel (not shown in the figure), but not limited to this.

When the display driving apparatus 1 receives an input data signal DIN, the compression module 10 will perform 1-bit compression on the input data signal DIN to generate a 1-bit compressed data and non-black data. It should be noticed that the non-black data includes color information of each non-black bit in the input data signal DIN.

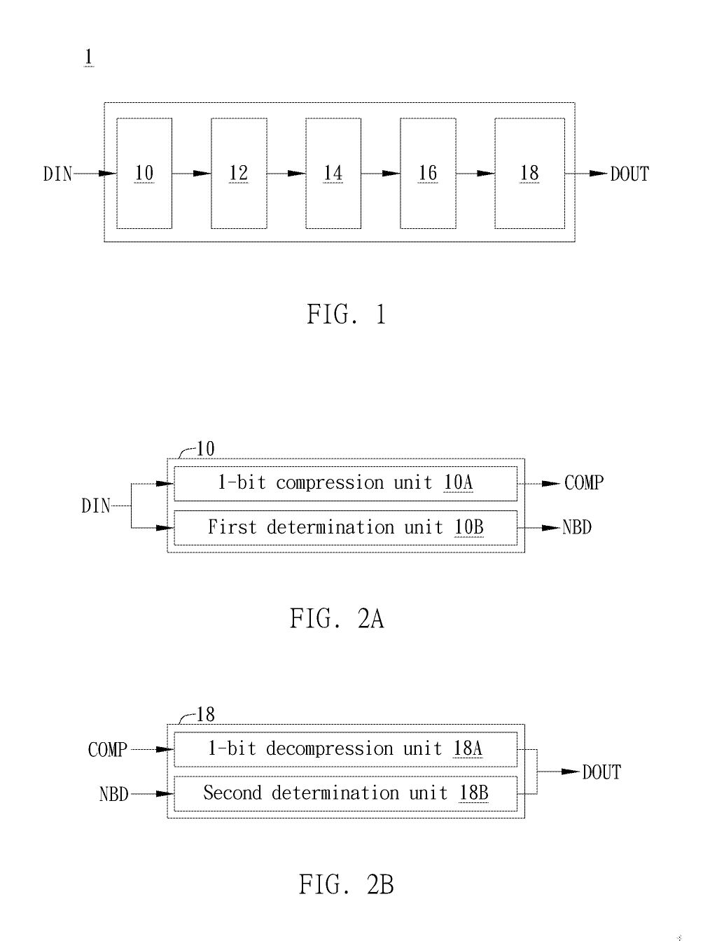

In an embodiment, please refer to FIG. 2A, the compression module 10 can include a 1-bit compression unit 10A and a first determination unit 10B. The 1-bit compression unit 10A is used for performing the 1-bit compression on the input data signal DIN and outputting the 1-bit compressed data COMP. The first determination unit 10B is used for determining whether each bit of the input data signal DIN corresponds to black respectively and generating the non-black data NBD including the color information of the each non-black bit in the input data signal DIN accordingly.

When the writing control module 12 receives the 1-bit compressed data COMP and the non-black data NBD from the compression module 10, the writing control module 12 is used for writing the 1-bit compressed data COMP and the non-black data NBD into the storing module 14, so that the 1-bit compressed data COMP and the non-black data NBD will be stored in the storing module 14 and wait to be read.

When the display panel is going to display image, the reading control module 16 will read the 1-bit compressed data COMP from the storing module 14 and then transmit the 1-bit compressed data COMP to the decompression module 18. And then, the decompression module 18 will perform 1-bit decompression on the 1-bit compressed data COMP to generate an output data signal DOUT to the display panel.

It should be noticed that when the decompression module 18 performs 1-bit decompression on the 1-bit compressed data COMP, the decompression module 18 will determine whether each bit of the 1-bit compressed data COMP corresponds to black. If the determination of the decompression module 18 is yes, it means that the bit corresponds to black; therefore, the bit will be displayed in black; if the determination of the decompression module 18 is no, it means that the bit corresponds to a color other than black; therefore, the reading control module 16 will read a color corresponding to the bit from the non-black data NBD stored in the storing module 14 and the bit is displayed in the color. For example, the color corresponding to the bit can be red or blue, but not limited to this.

In an embodiment, please refer to FIG. 2B, the decompression module 18 can include a 1-bit decompression unit 18A and a second determination unit 18B. Wherein, the 1-bit decompression unit 18A is used for performing the 1-bit decompression on the 1-bit compressed data COMP. The second determination unit 18B is used for determining whether each bit of the 1-bit compressed data COMP corresponds to black respectively. If the determination of the second determination unit 18B is yes, it means that the bit corresponds to black; therefore, the bit is directly displayed in black; if the determination of the second determination unit 18B is no, it means that the bit corresponds to a color other than black; therefore, the reading control module 16 will read the color corresponding to the bit from the non-black data NBD stored in the storing module 14 and the bit is displayed in the color. For example, the color corresponding to the bit can be red or blue, but not limited to this.

For example, when the display panel is operated in a power saving mode, the display panel only needs to display time and few images and most of other regions on the display panel only display black color. It is assumed that the display panel has a resolution of (400×400), wherein 90% regions of the display panel display black and other 10% regions of the display panel display the color other than black.

As to the prior art, the storing module of the display driving apparatus needs a storing space having at least 400×400×24=3,840,000 bits and when the display panel displays each frame of image, the storing module needs to be accessed 400×400=160,000 times to consume a lot of power.

As to the invention, it is assumed that the compression module 10 performs the 1-bit decompression on the input data signal DIN with a compression ratio of 100, the 1-bit compressed data COMP only needs a storing space having at least 400×400×24/100=38,400 bits and when the display panel displays the 1-bit compressed data COMP, the storing module 14 needs to be accessed 400×400/100=1,600 times; the non-black data NBD displayed by only 10% regions of the display panel needs a storing space having at least 400×400×24×10%=384,000 bits and when the display panel displays the non-black data NBD, the storing module 14 needs to be accessed 400×400×10%=16,000 times.

Therefore, the storing module 14 in this embodiment only needs a storing space having at least 38,400+384,000=422,400 bits and the storing module 14 needs to be accessed 1,600+16,000=17,600 times. That is to say, the storing space needed for the storing module 14 in this embodiment is about only 11% of the storing space needed for the storing module in the prior art and the times needed for the storing module 14 in this embodiment to be accessed is also about 11% of the times needed for the storing module in the prior art. As a result, the invention can largely reduce the required memory capacity and the power consumption for memory access, especially when the display panel is operated in the power saving mode or the standby mode.

Another embodiment of the invention is a display driving apparatus operating method. In this embodiment, the display driving apparatus operating method is used for operating a display driving apparatus. The display driving apparatus is coupled to a display panel and includes a storing module.

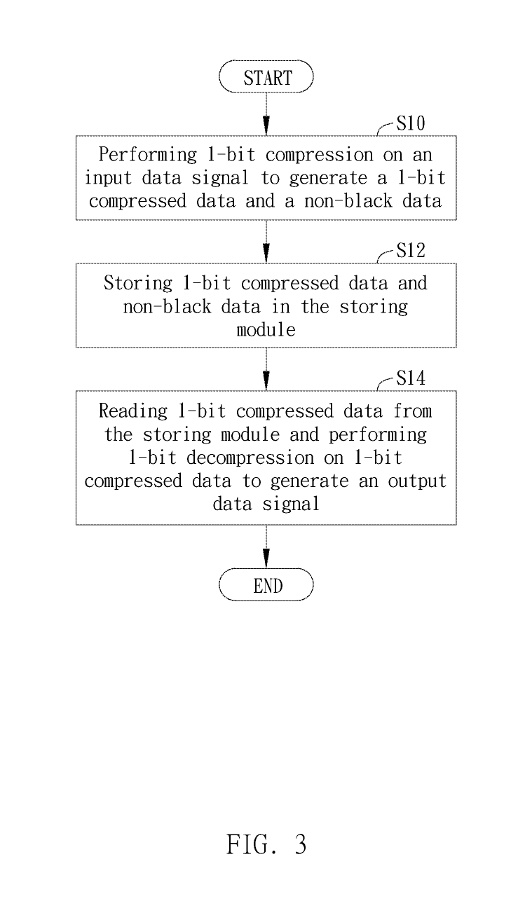

Please refer to FIG. 3. FIG. 3 illustrates a flowchart of the display driving apparatus operating method in this embodiment. As shown in FIG. 3, the display driving apparatus operating method can include the following steps S10˜S14:

Step S10: performing 1-bit compression on an input data signal to generate a 1-bit compressed data and a non-black data, wherein the non-black data includes color information of each non-black bit in the input data signal;

Step S12: storing the 1-bit compressed data and the non-black data in the storing module; and

Step S14: reading the 1-bit compressed data from the storing module and performing 1-bit decompression on the 1-bit compressed data to generate an output data signal. Wherein, Step S14 is to determine whether each bit of the 1-bit compressed data corresponds to black respectively. If yes, it means that the bit of the 1-bit compressed data corresponds to black, the method directly displays the bit in black; if no, it means that the bit of the 1-bit compressed data corresponds to a color other than black, the method reads a color corresponding to the bit from the non-black data stored in the storing module and then displays the bit in the color.

In practical applications, Step S10 can include following sub-steps of:

performing the 1-bit compression on the input data signal and outputting the 1-bit compressed data; and

determining whether each bit of the input data signal corresponds to black respectively and generating the non-black data comprising the color information of the each non-black bit in the input data signal accordingly.

In practical applications, Step S14 can include following sub-steps of:

performing the 1-bit decompression on the 1-bit compressed data; and

determining whether each bit of the 1-bit compressed data corresponds to black respectively; if yes, directly displaying the bit in black; if no, reading the color corresponding to the bit from the non-black data stored in the storing module and displaying the bit in the color.

In practical applications, between Step S10 and Step S12, the display driving apparatus operating method further includes a step of:

writing the 1-bit compressed data and the non-black data into the storing module.

Compared to the prior art, the display driving apparatus and operating method thereof in the invention not only can compress the display data with high compression ratio to reduce the required memory capacity and the power consumption for memory access, but also can display image without distortions. Therefore, the above-mentioned problems occurred in the prior arts can be solved by the display driving apparatus and operating method thereof in the invention.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A display driving apparatus, coupled to a display panel, the display driving apparatus comprising:
a compression module, for performing 1-bit compression on an input data signal to generate a 1-bit compressed data and a non-black data, wherein the non-black data comprises color information of each non-black bit in the input data signal;
a storing module, coupled to the compression module, for storing the 1-bit compressed data and the non-black data;
a reading control module, coupled to the storing module; and
a decompression module, coupled to the reading control module, wherein the reading control module reads the 1-bit compressed data from the storing module and the decompression module performs 1-bit decompression on the 1-bit compressed data to generate an output data signal;
wherein when the decompression module performs the 1-bit decompression on the 1-bit compressed data, the decompression module determines whether each bit of the 1-bit compressed data corresponds to black respectively; if yes, the bit is directly displayed in black; if no, the reading control module reads a color corresponding to the bit from the non-black data stored in the storing module and the bit is displayed in the color.

2. The display driving apparatus of claim 1, wherein the display panel is an OLED display panel.

3. The display driving apparatus of claim 1, wherein the compression module comprises:
a 1-bit compression unit, for performing the 1-bit compression on the input data signal and outputting the 1-bit compressed data; and
a first determination unit, for determining whether each bit of the input data signal corresponds to black respectively and generating the non-black data comprising the color information of the each non-black bit in the input data signal accordingly.

4. The display driving apparatus of claim 1, wherein the decompression module comprises:
a 1-bit decompression unit, for performing the 1-bit decompression on the 1-bit compressed data; and
a second determination unit, for determining whether each bit of the 1-bit compressed data corresponds to black respectively; if yes, the bit is directly displayed in black; if no, the reading control module reads the color corresponding to the bit from the non-black data stored in the storing module and the bit is displayed in the color.

5. The display driving apparatus of claim 1, further comprising:
a writing control module, coupled between the compression module and the storing module, for writing the 1-bit compressed data and the non-black data into the storing module.

6. A display driving apparatus operating method for operating a display driving apparatus, the display driving apparatus being coupled to a display panel and comprising a storing module, the display driving apparatus operating method comprising steps of:
(a) performing 1-bit compression on an input data signal to generate a 1-bit compressed data and a non-black data, wherein the non-black data comprises color information of each non-black bit in the input data signal;
(b) storing the 1-bit compressed data and the non-black data in the storing module; and
(c) reading the 1-bit compressed data from the storing module and performing 1-bit decompression on the 1-bit compressed data to generate an output data signal;
wherein the step (c) is to determine whether each bit of the 1-bit compressed data corresponds to black respectively; if yes, directly displaying the bit in black; if no, reading a color corresponding to the bit from the non-black data stored in the storing module and displaying the bit in the color.

7. The display driving apparatus operating method of claim 6, wherein the display panel is an OLED display panel.

8. The display driving apparatus operating method of claim 6, wherein the step (a) comprises steps of:
performing the 1-bit compression on the input data signal and outputting the 1-bit compressed data; and
determining whether each bit of the input data signal corresponds to black respectively and generating the non-black data comprising the color information of the each non-black bit in the input data signal accordingly.

9. The display driving apparatus operating method of claim 6, wherein the step (c) comprises steps of:
performing the 1-bit decompression on the 1-bit compressed data; and
determining whether each bit of the 1-bit compressed data corresponds to black respectively; if yes, directly displaying the bit in black; if no, reading the color corresponding to the bit from the non-black data stored in the storing module and displaying the bit in the color.

10. The display driving apparatus operating method of claim 6, wherein between the step (a) and the step (b),the display driving apparatus operating method further comprises a step of:
writing the 1-bit compressed data and the non-black data into the storing module.
